(19) United States
(12) Patent Application Publication
(10) Pub. No.: US 2009/0153827 A1
(43) Pub. Date: Jun. 18, 2009

(54) IMAGE READING APPARATUS

(75) Inventors: Motoari SHOJI, Kyoto (JP); Yasuhiro NAGAO, Kyoto (JP)

Correspondence Address: HAMRE, SCHUMANN, MUELLER & LARSON, P.C., P.O. BOX 2902, MINNEAPOLIS, MN, 55402-0902, US

(73) Assignee: ROHM CO., LTD., Kyoto (JP)

(21) Appl. No.: 12/332,889

(22) Filed: Dec. 11, 2008

(30) Foreign Application Priority Data
Dec. 13, 2007 (JP) 2007-321685
Dec. 14, 2007 (JP) 2007-322807

(51) Int. Cl. G03B 27/54

(52) U.S. Cl. 355/67

(57) ABSTRACT

An image reading apparatus includes a light source, a plurality of light receiving elements arranged in a primary scanning direction, and an optical part having either one of the function to direct light emitted from the light source toward an object to be read as linear light extending in the primary scanning direction and the function to guide reflected light of the linear light toward the light receiving elements. The light source, the light receiving elements and the optical part are accommodated in a case which is in the form of an elongated rectangle. The case is formed with an opening extending in the primary scanning direction. A glass cover is fitted in the opening, and part of the glass cover is bonded to part of the opening with resin. The case includes a pair of inner walls adjoining the opening and facing each other at a predetermined distance in a secondary scanning direction. The optical part includes a first surface facing an inner surface of the glass cover and a second surface facing one of the inner walls. The optical part is arranged along one of the paired inner walls. An inclined surface is provided between the first and the second surfaces. The inclined surface is so inclined as to become more distant from the inner surface of the glass cover as proceeding toward the second surface.

### BACKGROUND OF THE INVENTION

1. Field of the Invention

The present invention relates to an image reading apparatus.

2. Description of the Related Art

Conventionally, various types of image reading apparatuses have been proposed. An example of image reading apparatuses is disclosed in JP-A-2007-300536. In this conventional image reading apparatus, a light source is arranged to face an end surface of the light guide (see FIG. 3 of the document) so that the object to be read is uniformly irradiated with linear light with high brightness.

FIGS. 11 and 12 of the present application show an image reading apparatus as related art of the present invention. The illustrated image reading apparatus X includes a case 91 elongated in the primary scanning direction. The case accommodates a light guide 92, a lens unit 93, a substrate 94, a plurality of sensor chips 95 and an LED module 96. A glass cover 97 is fitted in the opening 91a formed at an upper portion of the case 91. The opening 91a of the case 91 includes a pair of supporting surfaces 911 (which are spaced from each other in the width direction of the case 91, i.e., in the secondary scanning direction and each elongated in the primary scanning direction) held in contact with the inner surface of the glass cover 97 and a pair of side wall surfaces 912 facing the side surfaces of the glass cover 97. To achieve close adhesion of the glass cover 97 to the supporting surface 911, resin 98 is arranged between the inner surface of the glass cover 97 and the supporting surface 911.

The case 91 is made by molding resin using a mold. In this process, to detach the case 91 from the mold, the supporting surfaces 911 are pushed by a plurality of ejector pins. As a result, the ejector pin traces 911a are formed on each of the supporting surface 911. As shown in FIG. 11, each of the ejector pin traces 911a formed in this way extends along the entire width (dimension in the secondary scanning direction) of the supporting surface 911.

The light guide 92 includes a light guiding member 92a, a reflector 92b and a light emitting surface 92c. The light emitted from the LED module 96 travels in the light guiding member 92a in the primary scanning direction and is emitted from the light emitting surface 92c as linear light. The linear light is reflected by the object to be read and then converged onto the sensor chips 95 by the lens unit 93. The sensor chips 95 are arranged on the substrate 94 in a row extending in the primary scanning direction.

In the image reading apparatus X, the resin 98 may be pushed out from between the supporting surface 911 and the glass cover 97. In this case, the resin 98 pushed out applies pressure to the light guiding member 92 and the lens unit 93 and may change the arrangement of these members. In such a case, the linear light emitted from the light guiding member 92 may not be properly directed to the object to be read or the light reflected by the object to be read may not be properly converged onto the sensor chips 95.

Moreover, in the image reading apparatus X, resin 98 may not spread completely between the ejector pin trace 911a and the glass cover 97, so that a gap may be defined between the supporting surface 911 and the glass cover 97. In such a case, foreign matter such as powder of paper enters the case 91, which may hinder proper image reading.

### SUMMARY OF THE INVENTION

The present invention has been proposed under the circumstances described above. It is, therefore, an object of the present invention to provide an image reading apparatus which is capable of achieving precise arrangement of an optical part and proper image reading.

According to a first aspect of the present invention, there is provided an image reading apparatus comprising a light source, a plurality of light receiving elements arranged in a primary scanning direction, and an optical part having a predetermined function. Examples of the function of the optical part include a function to direct light emitted from the light source toward an object to be read as linear light extending in the primary scanning direction and a function to guide reflected light of the linear light toward the light receiving elements. The light source, the light receiving elements and the optical part are accommodated in a case. The case is formed with an opening extending in the primary scanning direction, and a glass cover is fitted in the opening. Part of the glass cover is bonded to at least part of the opening with resin. The case includes a pair of inner walls adjoining the opening and facing each other at a predetermined distance in a secondary scanning direction. The optical part includes a first surface facing an inner surface of the glass cover and a second surface facing one of the inner walls. The optical part is arranged along one of the paired inner walls. An inclined surface is provided between the first and the second surfaces. The inclined surface is so inclined as to become more distant from the inner surface of the glass cover as proceeding toward the second surface.

With this arrangement, the portion of the optical part which is adjacent to the supporting surface is so designed as to proceed away from the glass cover. Thus, even when the resin projects from the supporting surface, the resin is unlikely to apply pressure to the optical part. As a result, the precise arrangement of the optical part at the proper position is ensured.

Preferably, the inner surface of the glass cover consists of a bonding region to be bonded to the opening and a non-bonding region, and the non-bonding region is designed to more readily repel resin than the bonding region does. With this arrangement, the resin is unlikely to project from the bonding region toward the non-bonding region.

Preferably, a supporting surface facing the inner surface of the glass cover and bonded to at least part of the inner surface of the glass cover is provided substantially along the entire length of the opening in the primary scanning direction. The supporting surface is formed with a plurality of ejector pin traces recessed in a direction to be away from the glass cover. The ejector pin traces are smaller than the supporting surface in dimension in the secondary scanning direction. With this arrangement, the ejector pin traces are made small so that the supporting surface includes a region which faces the inner surface of the glass cover at a constant distance substantially along the entire length in the primary scanning direction. This arrangement ensures close adhesion of the supporting surface to the glass cover via the resin substantially along the entire length in the primary scanning direction. Thus, foreign matter is unlikely to enter the case, whereby proper image reading is performed.

Preferably, the ejector pin trace includes a bottom surface facing the inner surface of the glass cover and an inclined surface which is so inclined as to become closer to the inner surface of the glass cover as proceeding away from center of the bottom surface. With this arrangement, the resin readily spreads between the ejector pin trace and the supporting surface, whereby close adhesion of the glass cover to the supporting surface is reliably achieved.

According to a second aspect of the present invention, there is provided an image reading apparatus comprising a light source, a plurality of light receiving elements arranged in a primary scanning direction, a light guide for directing light emitted from the light source toward an object to be read as linear light extending in the primary scanning direction, a lens member for guiding reflected light of the linear light toward the light receiving elements, a case which accommodates the light source, the light receiving elements, the light guide and the lens member, which is in the form of an elongated rectangle and which includes an opening extending in the primary scanning direction, and a glass cover fitted in the opening. The opening is provided with a supporting surface facing the inner surface of the glass cover and bonded to at least part of the inner surface of the glass cover. The supporting surface is formed with a plurality of ejector pin traces recessed in a direction to be away from the glass cover. The supporting surface is provided substantially along the entire length of the opening in the primary scanning direction, and the ejector pin traces are smaller than the supporting surface in dimension in the secondary scanning direction.

With this arrangement, the ejector pin traces are made small so that the supporting surface includes a region which faces the inner surface of the glass cover at a constant distance substantially along the entire length in the primary scanning direction. This arrangement ensures close adhesion of the supporting surface to the glass cover via the resin substantially along the entire length in the primary scanning direction. Thus, in this image reading apparatus, foreign matter is unlikely to enter the case, whereby proper image reading is performed.

Preferably, the ejector pin trace includes a bottom surface facing the inner surface of the glass cover and an inclined surface which is so inclined as to become closer to the inner surface of the glass cover as proceeding away from center of the bottom surface. With this arrangement, due to the presence of the inclined surface, the resin readily flows into the ejector pin trace. Thus, the close adhesion of the glass cover to the supporting surface is reliably achieved.

Preferably, the opening includes a side wall surface facing a side surface of the glass cover, and the side wall surface is formed with a resin injection hole communicating with outside. With this arrangement, resin is injected into the resin injection hole after the glass cover is fitted into the opening. The resin infiltrates by capillarity and bonds the glass cover to the opening. Thus, the resin is unlikely to be excessive and does not overflow the opening.

Other features and advantages of the present invention will become more apparent from the detailed description given below with reference to the accompanying drawings.

### BRIEF DESCRIPTION OF THE DRAWINGS

FIG. 1 is a plan view showing an image reading apparatus according to a first embodiment of the present invention.

FIG. 2 is a front view showing the image reading apparatus of FIG. 1.

FIG. 3 is a sectional view taken along lines III-III in FIG. 2.

FIG. 4 is a plan view showing an image reading apparatus according to a second embodiment of the present invention.

FIG. 5 is a front view showing the image reading apparatus of FIG. 4.

FIG. 6 is a sectional view taken along lines VI-VI in FIG. 4.

FIG. 7 is an enlarged view showing a principal portion of the image reading apparatus shown in FIG. 4.

FIG. 8 is a plan view showing an image reading apparatus according to a third embodiment of the present invention.

FIG. 9 is a front view showing the image reading apparatus of FIG. 8.

FIG. 10 is a sectional view taken along lines X-X in FIG. 8.

FIG. 11 is a plan view showing an example of image reading apparatus as related art of the present invention.

FIG. 12 is a sectional view taken along lines XII-XII in FIG. 11.

### DETAILED DESCRIPTION OF THE PREFERRED EMBODIMENTS

Preferred embodiments of the present invention will be described below with reference to the accompanying drawings.

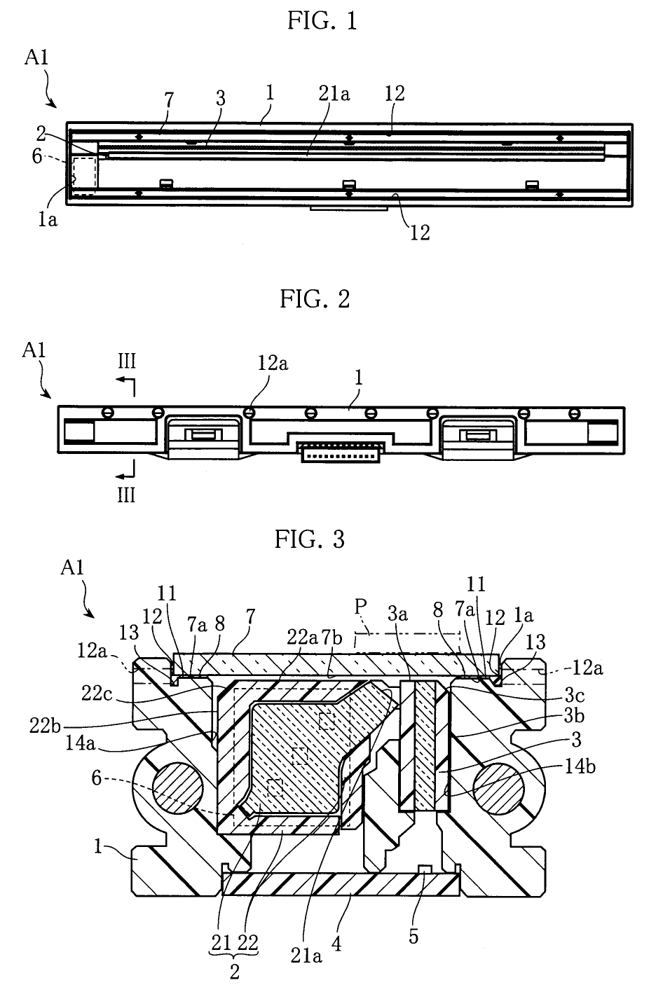

FIGS. 1-3 show an image reading apparatus according to a first embodiment of the present invention. The illustrated image reading apparatus A1 includes a case 1, a light guide 2, a lens unit 3, a substrate 4, sensor chips 5, an LED module 6 and a glass cover 7.

The case 1 accommodates the light guide 2, the lens unit 3, the substrate 4, the sensor chips 5 and the LED module 6. The case is generally in the form of a rectangular parallelepiped extending in the primary scanning direction and includes an upper portion formed with an opening 1a in which the glass cover 7 is fitted. As shown in FIG. 1, the opening 1a is in the form of a rectangle having a long side extending in the primary scanning direction and a short side extending in the secondary scanning direction. As shown in FIG. 3, the opening 1a includes a pair of supporting surfaces 11, a pair of side wall surfaces 12 and two grooves 13. The case 1 includes another opening at the lower portion.

Each of the paired supporting surfaces 11 extends along a long side of the opening 1a to face the inner surface of the glass cover 7 and is in the form of a rectangle elongated in the primary scanning direction. The paired supporting surfaces 11 are bonded, via the resin 8, to the two edges the glass cover 7 which extend in the primary scanning direction. The paired side wall surfaces 12 stand relative to the paired supporting surfaces 11 and face the two side surfaces of the glass cover 7. The paired side wall surfaces 12 sandwich and hold the glass cover 7 in the secondary scanning direction. Each of the side wall surfaces 12 is formed with resin injection holes 12a communicating with the outside of the case 1. Specifically, as shown in FIG. 2, one of the paired side wall surfaces 12 is formed with eight resin injection holes 12a arranged in a row. Similarly, the other one of the side wall surfaces 12 is formed with eight resin injection holes 12a arranged in a row. Each of the two grooves 13 extends along a long side of the opening 1a. The groove 13 is positioned between the supporting surface 11 and the side wall surface 12 and recessed relative to the supporting surface 11.

As shown in FIG. 3, the case 1 includes a pair of inner surfaces 14a and 14b extending in the primary scanning direction and facing each other at a predetermined distance in the secondary scanning direction. The inner surface 14a is connected perpendicularly to one of the supporting surfaces 11 at an edge adjacent to the opening 1a. The inner surface 14b is connected perpendicularly to the other one of the supporting surfaces 11 at an edge adjacent to the opening 1a. For instance, the case 1 is made of black resin.

The light guide 2 comprises a light guiding member 21 and a reflector 22. For instance, the light guiding member 21 is made of a transparent resin such as polymethyl methacrylate (PMMA). The light traveling from the LED module 6 is emitted from the light emitting surface 21a of the light guiding member as linear light extending in the primary scanning direction.

The light guiding member 21 extends in the primary scanning direction and includes an end formed with a light incident surface facing the LED module 6. The reflector 22 serves to prevent the light traveling within the light guiding member 21 from unduly leaking to the outside. For instance, the reflector is made of white resin. As shown in FIG. 3, the reflector 22 surrounds the light guiding member 21. The reflector 22 includes a first surface 22a facing the inner surface of the glass cover 7, a second surface 22b facing the inner surface 14a, and an inclined surface 22c extending between the first surface 22a and the second surface 22b. The inclined surface 22c is inclined 45° with respect to the first surface 22a to become more distant from the inner surface of the glass cover 7 as proceeding toward the second surface 22b. The inclined surface 22c is in the form of a rectangle having a long side extending substantially along the entire length of the reflector 22 in the primary scanning direction and a short side of not less than e.g. 3 mm. The inclined surface 22c can be easily formed by resin-molding the reflector 22 using a mold having an inclined surface corresponding to the inclined surface 22c.

The lens unit 3 comprises a plurality of columnar lenses arranged in the primary scanning direction and held by a housing made of resin. By the function of the lenses, the lens unit 3 converges the linear light reflected by the object P to be read onto the sensor chips 5. As shown in FIG. 3, the housing of the lens unit 3 includes a first surface 3a facing the inner surface of the glass cover 7, a second surface 3b facing the inner surface 14b and an inclined surface 3c extending between the first surface 3a and the second surface 3b. The inclined surface 3c is inclined 45° with respect to the first surface 3a to become more distant from the inner surface of the glass cover 7 as proceeding toward the second surface 3b. The inclined surface 3c is in the form of a rectangle having a long side extending substantially along the entire length of the housing of the lens unit 3 in the primary scanning direction and a short side of not less than e.g. 3 mm. The inclined surface 3c can be easily formed by resin-molding the housing of the lens unit 3 using a mold having an inclined surface corresponding to the inclined surface 3c.

The substrate 4, upon which the sensor chips 5 are mounted, is made of a ceramic material or a glass-fiber-reinforced epoxy resin, and electrically connected to the LED module 6. The substrate 4 is in the form of a rectangle extending in the primary scanning direction and fitted in the lower opening of the case 1.

The sensor chips 5 are light receiving elements arranged on the substrate 4 in a row extending in the primary scanning direction. The sensor chips 5 generate electromotive force corresponding to the received amount of light and output a luminance signal for each pixel from the electromotive force. In the image reading apparatus A1, by receiving the light reflected by the object P to be read by the sensor chips 5, the content of the object P is read as image data.

The LED module 6 is a light source incorporating LED chips for emitting e.g. red light, blue light and green light. The LED module 6 is arranged at an end portion of the case 1 in the primary scanning direction so that the light emitting surfaces of the LED chips incorporated in the module face an end of the light guiding member 2 in the primary scanning direction.

Alternatively, a light guiding member including a light incident surface extending in parallel with the substrate 4 may be employed. In this case, the LED module can be so mounted on the substrate 4 that the light emitting surfaces of the LED chips face the light incident surface of the light guiding member.

The glass cover 7 is generally in the form of a rectangular parallelepiped elongated in the primary scanning direction. As shown in FIG. 3, the glass cover comprises bonding regions 7a bonded to the supporting surfaces 11 via the resin 8 and the remaining non-bonding region 7b. The bonding regions 7a are provided at the two edges of the glass cover 7 which extend in the primary scanning direction. A water-repellent surfactant is applied to the non-bonding region 7b.

As the resin for bonding the supporting surfaces 11 and the bonding regions 7a to each other, use may be made of a resin having a viscosity of e.g. 250 to 2000 mPa/s. With the glass cover 7 fitted into the opening 1a, the resin is injected into each groove 13 through the resin injection holes 12a. The resin 8 overflowing the groove 13 infiltrates between the supporting surface 11 and the bonding region 7a by capillarity and bond these portions together. With this arrangement, the resin 8 is unlikely to be excessive, and the resin 8 does not overflow the space between the supporting surface 11 and the bonding region 7a.

The advantages of the image reading apparatus A1 will be described below.

Since the reflector 22 of the image reading apparatus A1 includes the inclined surface 22c, the resin 8 is unlikely to adhere to the reflector 22. This ensures the precise arrangement of the reflector 22 and the light guiding member 21 held by the reflector at the proper position. As a result, the linear light emitted from the light guide 2 is directed precisely to the object P to be read, whereby the image reading apparatus A1 obtains proper image data.

Moreover, since the housing of the lens unit 3 includes the inclined surface 3c, the resin 8 is unlikely to adhere to the lens unit 3. This ensures the precise arrangement of the lens unit 3 at the proper position. As a result, the light reflected by the object P to be read is converged precisely onto the sensor chips 5 by the lens unit 3, whereby the image reading apparatus A1 obtains proper image data.

Further, since a water-repellent surfactant is applied to the non-bonding region 7b, the resin 8 is unlikely to filtrate from between the supporting surface 11 and the bonding region 7a into the non-bonding region 7b. This also prevents the resin 8 from adhering to the light guiding member 2 and the lens unit 3 and hence ensures that the image reading apparatus A1 obtains proper image data.

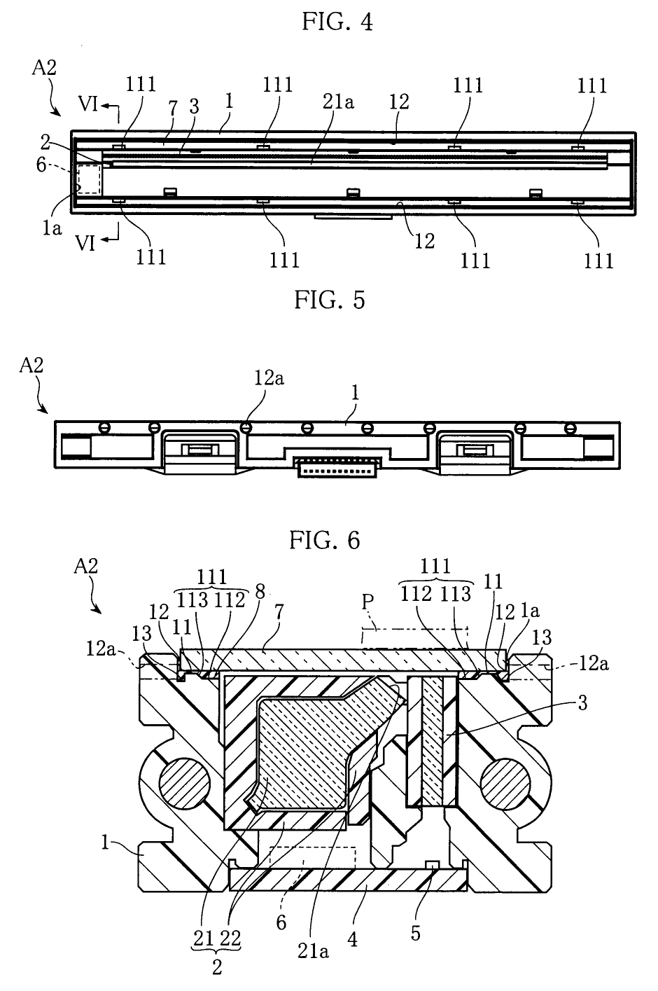

FIGS. 4-7 show an image reading apparatus according to a second embodiment of the present invention. The illustrated image reading apparatus A2 includes a case 1, a light guide 2, a lens unit 3, a substrate 4, sensor chips 5, an LED module 6 and a glass cover 7.

The case 1 accommodates the light guide 2, the lens unit 3, the substrate 4, the sensor chips 5 and the LED module 6. The case is generally in the form of a rectangular parallelepiped extending in the primary scanning direction and includes an upper portion formed with an opening 1a in which the glass cover 7 is fitted. As shown in FIG. 4, the opening 1a is in the form of a rectangle having a long side extending in the primary scanning direction and a short side extending in the secondary scanning direction. As shown in FIG. 6, the opening 1a includes a pair of supporting surfaces 11, a pair of side wall surfaces 12 and two grooves 13. The case 1 includes another opening at the lower portion. The case 1 is made by injecting resin into a mold, hardening the resin and then pushing the case out of the mold using a plurality of ejector pins.

Each of the paired supporting surfaces 11 extends along a long side of the opening 1a to face the inner surface of the glass cover 7 and is in the form of a rectangle elongated in the primary scanning direction. The paired supporting surfaces 11 are bonded, via the resin 8, to the two edges of the glass cover 7 which extend in the primary scanning direction. Each of the supporting surfaces 11 is formed with four ejector pin traces 111 arranged in the primary scanning direction. The region of the supporting surface 11 other than the ejector pin traces 111 faces the inner surface of the glass cover 7 at a constant distance substantially along the entire length of the long side of the opening 1a. Relative to this region, the ejector pin traces 111 are recessed in the direction away from the inner surface of the glass cover 7.

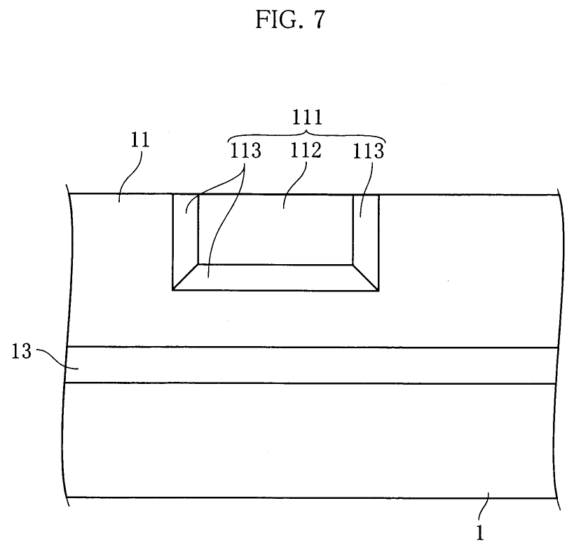

As shown in FIGS. 6 and 7, each of the ejector pin traces 111 comprises a bottom surface 112 and an inclined surface 113. The bottom surface 112 is in the form of a rectangle extending in the primary scanning direction and faces the inner surface of the glass cover 7. The inner long side of the bottom surface 112 corresponds to the inner long side of the supporting surface 11. The outer long side and the two short sides of the bottom surface 112 are connected to the inclined surface 113. The inclined surface 113 is inclined 45° with respect to the bottom surface 112 to become closer to the inner surface of the glass cover 7 as proceeding away from the center of the bottom surface 112. The edge of the inclined surface 113 which is opposite to the edge adjoining the outer long side of the bottom surface 112 is spaced inward from the outer long side of the supporting surface 11 by a predetermined distance.

The ejector pin traces 111 are formed in the process of manufacturing the case 1 by pushing the supporting surface 11 by ejector pins to push the case 1 out of the mold. In this process, use is made of ejector pins whose dimension in the secondary scanning direction is smaller than that of the supporting surface 11. By this, the ejector pin traces 111 are formed whose dimension in the secondary scanning direction is smaller than that of the supporting surface 11. As noted before, the ejector pin trace 111 including the inclined surface 113 can be formed by using an ejector pin including an inclined surface corresponding to the inclined surface 113.

The paired side wall surfaces 12 stand relative to the paired supporting surfaces 11 and face the two side surfaces of the glass cover 7. The paired side wall surfaces 12 sandwich and hold the glass cover 7 in the secondary scanning direction. Each of the side wall surfaces 12 is formed with resin injection holes 12a communicating with the outside of the case 1. Specifically, as shown in FIG. 5, one of the paired side wall surfaces 12 is formed with eight resin injection holes 12a arranged in a row. Similarly, the other one of the side wall surfaces 12 is formed with eight resin injection holes 12a arranged in a row. Each of the two grooves 13 extends along a long side of the opening 1a. The groove 13 is positioned between the outer long side of the supporting surface 11 and the side wall surface 12 and recessed relative to the supporting surface 11 in the direction away from the inner surface of the glass cover 7. For instance, the case 1 is made of black resin.

The light guide 2 comprises a light guiding member 21 and a reflector 22. For instance, the light guiding member 21 is made of a transparent resin such as polymethyl methacrylate (PMMA). The light traveling from the LED module 6 is emitted from the light emitting surface 21a of the light guiding member as linear light extending in the primary scanning direction. The light guiding member 21 extends in the primary scanning direction and includes an end formed with a light incident surface facing the substrate 4 and an inclined portion inclined with respect to the light incident surface. The inclined portion is designed to reflect the light entering through the light incident surface to cause the light to travel in the primary scanning direction. The reflector 22 serves to prevent the light traveling within the light guiding member 21 from unduly leaking to the outside. For instance, the reflector is made of white resin. As shown in FIG. 6, the reflector 22 surrounds the light guiding member 21.

The lens unit 3 comprises a plurality of columnar lenses arranged in the primary scanning direction and held by a housing made of resin. By the function of the lenses, the lens unit 3 converges the linear light reflected by the object P to be read onto the sensor chips 5.

The substrate 4 is made of a ceramic material or a glass-fiber-reinforced epoxy resin. The sensor chips 5 and the LED module 6 are mounted on the substrate. The substrate 4 is in the form of a rectangle extending in the primary scanning direction and fitted in the lower opening of the case 1.

The sensor chips 5 are arranged on the substrate 4 in a row extending in the primary scanning direction. The sensor chips 5 generate electromotive force corresponding to the received amount of light and outputs a luminance signal for each pixel from the electromotive force. In the image reading apparatus A2, by receiving the light reflected by the object P to be read by the sensor chips 5, the content of the object P is read as image data.

The LED module 6 is a light source incorporating LED chips for emitting e.g. red light, blue light and green light. The LED module 6 is arranged at an end portion of the substrate 4 in the primary scanning direction so that the light emitting surfaces of the LED chips incorporated in the module face the light incident surface of the light guiding member 21.

The glass cover 7 is generally in the form of a rectangular parallelepiped elongated in the primary scanning direction and fitted in the opening 1a. The two edges of the inner surface of the glass cover 7 which extend in the primary scanning direction are bonded to the paired supporting surfaces 11 via the resin 8. As the resin 8, use may be made of a resin having a viscosity of e.g. 250 to 2000 mPa/s. With the glass cover 7 fitted into the opening 1a, the resin is injected into each groove 13 through the resin injection holes 12a. The resin 8 overflowing the groove 13 infiltrates between the supporting surface 11 and the inner surface of the glass cover 7 by capillarity and bond these portions together.

The advantages of the image reading apparatus A2 will be described below.

In the image reading apparatus A2, the outer edge of each ejector pin trace 111 is spaced inward from the outer edge of the supporting surface 11. Thus, substantially along the entire length of the supporting surface 11 in the primary scanning direction, the portion of the supporting surface 11 adjacent to the outer edge faces the glass cover 7 at a constant distance and without being recessed. Thus, the resin 8 which infiltrates by capillarity readily spreads between the inner surface of the glass cover 7 and the supporting surface 11, thereby bonding the glass cover 7 and the supporting surface 11 together without leaving a gap therebetween. In this image reading apparatus A2, the entry of foreign matter through a gap between the glass cover 7 and the supporting surface 11 is unlikely to occur. Thus, the breakdown of the image reading apparatus is unlikely to occur, and proper image reading is performed.

Moreover, since each ejector pin trace 111 is formed with the inclined surface 113, the resin 8 readily flows from the inclined surface 113 toward the bottom surface 112. Thus, the space between the ejector pin trace 111 and the inner surface of the glass cover 7 is readily filled with the resin 8. This ensures the close adhesion of the glass cover 97 to the supporting surface 11.

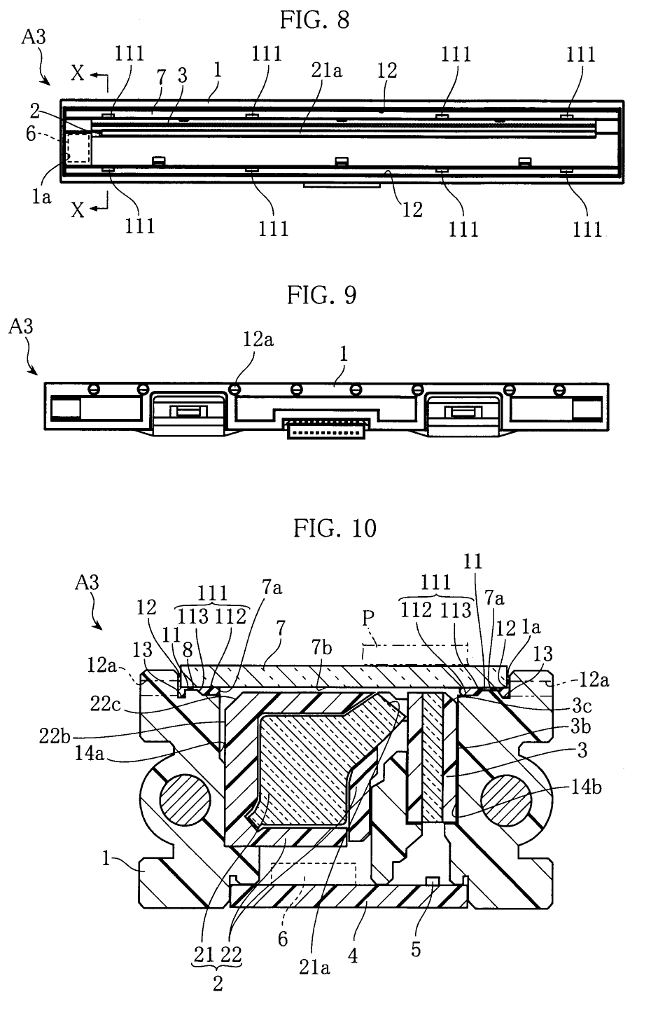

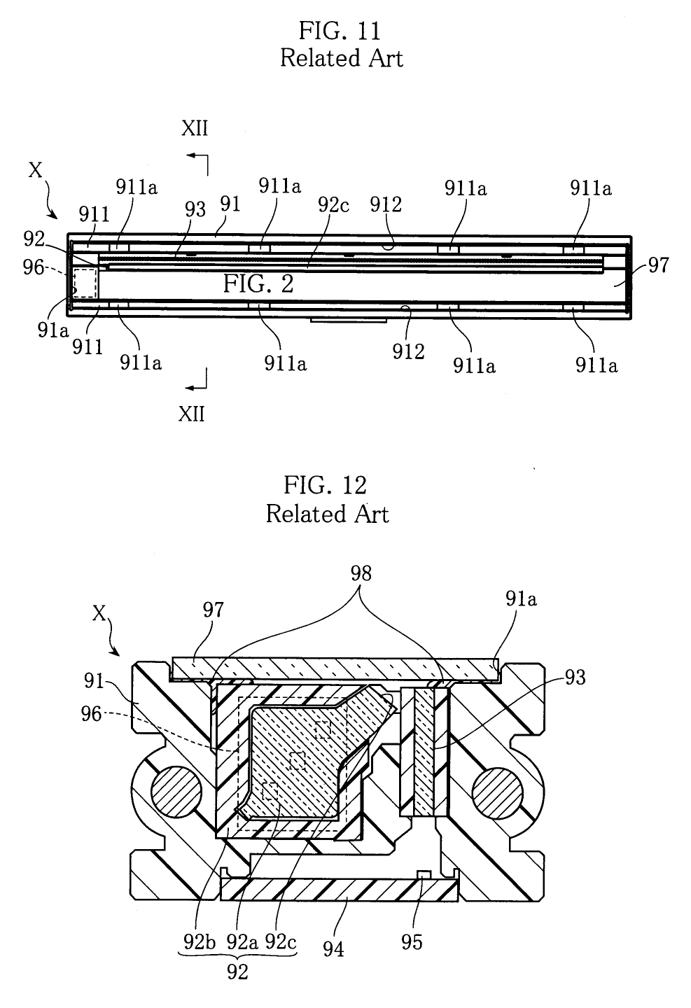

FIGS. 8-10 show an image reading apparatus according to a third embodiment of the present invention. The illustrated image reading apparatus A3 includes a case 1, a light guide 2, a lens unit 3, a substrate 4, sensor chips 5, an LED module 6 and a glass cover 7.

The case 1 accommodates the light guide 2, the lens unit 3, the substrate 4, the sensor chips 5 and the LED module 6. The case is generally in the form of a rectangular parallelepiped extending in the primary scanning direction and includes an upper portion formed with an opening 1a in which the glass cover 7 is fitted. The opening 1a is in the form of a rectangle having a long side extending in the primary scanning direction and a short side extending in the secondary scanning direction. The opening 1a includes a pair of supporting surfaces 11, a pair of side wall surfaces 12 and two grooves 13. The case 1 includes another opening at the lower portion. The case 1 is made by injecting resin into a mold, hardening the resin and then pushing the case out of the mold using a plurality of ejector pins.

Each of the paired supporting surfaces 11 extends along a long side of the opening 1a to face the inner surface of the glass cover 7 and is in the form of a rectangle elongated in the primary scanning direction. The paired supporting surfaces 11 are bonded, via the resin 8, to the two edges of the glass cover 7 which extend in the primary scanning direction. Each of the supporting surfaces 11 is formed with four ejector pin traces 111 arranged in the primary scanning direction. The region of the supporting surface 11 other than the ejector pin traces 111 faces the inner surface of the glass cover 7 at a constant distance substantially along the entire length of the long side of the opening 1a. Relative to this region, the ejector pin traces 111 are recessed in the direction away from the inner surface of the glass cover 7.

Each of the ejector pin traces 111 comprises a bottom surface 112 and an inclined surface 113. The bottom surface 112 is in the form of a rectangle extending in the primary scanning direction and faces the inner surface of the glass cover 7. The inner long side of the bottom surface 112 corresponds to the inner long side of the supporting surface 11. The outer long side and the two short sides of the bottom surface 112 are connected to the inclined surface 113. The inclined surface 113 is inclined 45° with respect to the bottom surface 112 to become closer to the inner surface of the glass cover 7 as proceeding away from the center of the bottom surface 112. The edge of the inclined surface 113 which is opposite to the edge adjoining the outer long side of the bottom surface 112 is spaced inward from the outer long side of the supporting surface 11 by a predetermined distance.

The ejector pin traces 111 are formed in the process of manufacturing the case 1 by pushing the supporting surface 11 by ejector pins to push the case 1 out of the mold. In this process, use is made of ejector pins whose dimension in the secondary scanning direction is smaller than that of the supporting surface 11. By this, the ejector pin traces 111 are formed whose dimension in the secondary scanning direction is smaller than that of the supporting surface 11. The ejector pin trace 111 including the inclined surface 113 can be formed by using an ejector pin including an inclined surface corresponding to the inclined surface 113.

The paired side wall surfaces 12 stand relative to the paired supporting surfaces 11 and face the two side surfaces of the glass cover 7. The paired side wall surfaces 12 sandwich and hold the glass cover 7 in the secondary scanning direction. Each of the side wall surfaces 12 is formed with resin injection holes 12a communicating with the outside of the case 1. Specifically, as shown in FIG. 9, one of the paired side wall surfaces 12 is formed with eight resin injection holes 12a arranged in a row. Similarly, the other one of the side wall surfaces 12 is formed with eight resin injection holes 12a arranged in a row. Each of the two grooves 13 extends along a long side of the opening 1a. The groove 13 is positioned between the outer long side of the supporting surface 11 and the side wall surface 12 and recessed relative to the supporting surface 11 in the direction away from the inner surface of the glass cover 7.

The case 1 further includes a pair of inner surfaces 14a and 14b extending in the primary scanning direction and facing each other at a predetermined distance in the secondary scanning direction. The inner surface 14a is connected perpendicularly to one of the supporting surfaces 11 at an edge adjacent to the opening 1a. The inner surface 14b is connected perpendicularly to the other one of the supporting surfaces 11 at an edge adjacent to the opening 1a. For instance, the case 1 is made of black resin.

The light guide 2 comprises a light guiding member 21 and a reflector 22. For instance, the light guiding member 21 is made of a transparent resin such as polymethyl methacrylate (PMMA). The light traveling from the LED module 6 is emitted from the light emitting surface 21a of the light guiding member as linear light extending in the primary scanning direction. The light guiding member 21 extends in the primary scanning direction and includes an end formed with a light incident surface facing the LED module 6. The reflector 22 serves to prevent the light traveling within the light guiding member 21 from unduly leaking to the outside. For instance, the reflector is made of white resin. As shown in FIG. 10, the reflector 22 surrounds the light guiding member 21. The reflector 22 includes a first surface 22a facing the inner surface of the glass cover 7, a second surface 22b facing the inner surface 14a, and an inclined surface 22c extending between the first surface 22a and the second surface 22b. The inclined surface 22c is inclined 45° with respect to the first surface 22a to become more distant from the inner surface of the glass cover 7 as proceeding toward the second surface 22b. The inclined surface 22c is in the form of a rectangle having a long side extending substantially along the entire length of the reflector 22 in the primary scanning direction and a short side of not less than e.g. 3 mm. The inclined surface 22c can be easily formed by resin-molding the reflector 22 using a mold having an inclined surface corresponding to the inclined surface 22c.

The lens unit 3 comprises a plurality of columnar lenses arranged in the primary scanning direction and held by a housing made of resin. By the function of the lenses, the lens unit 3 converges the linear light reflected by the object P to be read onto the sensor chips 5. As shown in FIG. 10, the housing of the lens unit 3 includes a first surface 3a facing the inner surface of the glass cover 7, a second surface 3b facing the inner surface 14b and an inclined surface 3c extending between the first surface 3a and the second surface 3b. The inclined surface 3c is inclined 45° with respect to the first surface 3a to become more distant from the inner surface of the glass cover 7 as proceeding toward the second surface 3b. The inclined surface 3c is in the form of a rectangle having a long side extending substantially along the entire length of the housing of the lens unit 3 in the primary scanning direction and a short side of not less than e.g. 3 mm. The inclined surface 3c can be easily formed by resin-molding the housing of the lens unit 3 using a mold having an inclined surface corresponding to the inclined surface 3c.

The substrate 4, upon which the sensor chips are mounted, is made of a ceramic material or a glass-fiber-reinforced epoxy resin, and electrically connected to the LED module 6. The substrate 4 is in the form of a rectangle extending in the primary scanning direction and fitted in the lower opening of the case 1.

The sensor chips 5 are arranged on the substrate 4 in a row extending in the primary scanning direction. The sensor chips 5 generate electromotive force corresponding to the received amount of light and output a luminance signal for each pixel from the electromotive force. In the image reading apparatus A3, by receiving the light reflected by the object P to be read by the sensor chips 5, the content of the object P is read as image data.

The LED module 6 is a light source incorporating LED chips for emitting e.g. red light, blue light and green light. The LED module 6 is arranged at an end portion of the substrate 4 in the primary scanning direction so that the light emitting surfaces of the LED chips incorporated in the module face the light incident surface of the light guiding member 21.

The glass cover 7 is generally in the form of a rectangular parallelepiped elongated in the primary scanning direction. As shown in FIG. 10, the glass cover comprises bonding regions 7a bonded to the supporting surfaces 11 via the resin 8 and the remaining non-bonding region 7b. The bonding regions 7a are provided at the two edges of the glass cover 7 which extend in the primary scanning direction. A water-repellent surfactant is applied to the non-bonding region 7b.

As the resin for bonding the supporting surfaces 11 and the bonding regions 7a to each other, use may be made of a resin having a viscosity of e.g. 250 to 2000 mPa/s. With the glass cover 7 fitted into the opening 1a, the resin is injected into each groove 13 through the resin injection holes 12a. The resin 8 overflowing the groove 13 infiltrates between the supporting surface 11 and the bonding region 7a by capillarity and bond these portions together. With this arrangement, the resin 8 is unlikely to be excessive, and the resin 8 does not overflow the space between the supporting surface 11 and the bonding region 7a.

Similarly to the image reading apparatus A1, the reflector 22 of the image reading apparatus A3 includes the inclined surface 22c, so that the resin 8 is unlikely to adhere to the reflector 22. This ensures the precise arrangement of the reflector 22 and the light guiding member 21 held by the reflector at the proper position. As a result, the linear light emitted from the light guiding member 2 is directed precisely to the object P to be read, whereby the image reading apparatus A3 obtains proper image data.

Moreover, since the housing of the lens unit 3 includes the inclined surface 3c, the resin 8 is unlikely to adhere to the lens unit 3. This ensures the precise arrangement of the lens unit 3 at the proper position. As a result, the light reflected by the object P to be read is converged precisely onto the sensor chips 5 by the lens unit 3, whereby the image reading apparatus A3 obtains proper image data.

Further, since a water-repellent surfactant is applied to the non-bonding region 7b, the resin 8 is unlikely to filtrate from between the supporting surface 11 and the bonding region 7a into the non-bonding region 7b. This also prevents the resin 8 from adhering to the light guiding member 2 and the lens unit 3 and hence ensures that the image reading apparatus A3 obtains proper image data.

Moreover, similarly to the image reading apparatus A2, the outer edge of each ejector pin trace 111 of the image reading apparatus A3 is spaced inward from the outer edge of the supporting surface 11. Thus, substantially along the entire length of the supporting surface 11 in the primary scanning direction, the portion of the supporting surface 11 adjacent to the outer edge faces the glass cover 7 at a constant distance and without being recessed. Thus, the resin 8 which infiltrates by capillarity readily spreads between the inner surface of the glass cover 7 and the supporting surface 11, whereby close adhesion of the glass cover 7 to the supporting surface 11 is achieved. In this image reading apparatus A3, the entry of foreign matter through a gap between the glass cover 7 and the supporting surface 11 is unlikely to occur. Thus, the breakdown of the image reading apparatus is unlikely to occur, and proper image reading is performed.

Moreover, since each ejector pin trace 111 is formed with the inclined surface 113, the resin 8 readily flows from the inclined surface 113 toward the bottom surface 112. Thus, the space between the ejector pin trace 111 and the inner surface of the glass cover 7 is readily filled with the resin 8. This ensures the close adhesion of the glass cover 97 to the supporting surface 11.

The image reading apparatus of the present invention is not limited to the foregoing embodiments. For instance, in the first or the third embodiment, the angle of inclination of the inclined surfaces 33c and 3c with respect to the first surfaces 22a and 3a is not limited to 45°, and it is only necessary that these surfaces are inclined to become more distant from the glass cover 7 as proceeding toward the second surfaces 22b and 3b. Further, the inclined surface 22c or the inclined surface 3c may comprise a plurality of surfaces. The inclined surfaces 22c and 3c may be formed by molding resin using a mold which does not include an inclined surface and then performing cutting.

In the second and the third embodiment, the ejector pin traces 111 may not include the inclined surface 113. With this arrangement again, the close adhesion of the glass cover 7 to the receiving surface 11 is achieved when the outer edge of each ejector pin trace 111 is spaced inward from the outer edge of the supporting surface 11.

In the examples described above, the inner edge of each ejector pin trace 111 corresponds to the inner edge of the supporting surface 11. Unlike this, however, the two edges of each ejector pin 111 which are spaced in the secondary scanning direction may be positioned inward from the corresponding edges of the supporting surface 11. Although the above-described bottom surface 112 is in the form of a rectangle extending in the primary scanning direction, the bottom surface may be in the form of a rectangle extending in the secondary scanning direction, may be circular or may have other shapes.

1. An image reading apparatus comprising:
a light source;
a plurality of light receiving elements arranged in a primary scanning direction;
an optical part having either one of a function to direct light emitted from the light source toward an object to be read as linear light extending in the primary scanning direction and a function to guide reflected light of the linear light toward the light receiving elements;
a case accommodating the light source, the light receiving elements and the optical part, the case being in the form of an elongated rectangle and including an opening extending in the primary scanning direction; and
a glass cover which is fitted in the opening and part of which is bonded to at least part of the opening with resin;
wherein the case includes a pair of inner walls adjoining the opening and facing each other at a predetermined distance in a secondary scanning direction;
wherein the optical part includes a first surface facing an inner surface of the glass cover and a second surface facing one of the inner walls, the optical part being arranged along one of the paired inner walls; and
wherein an inclined surface is provided between the first and the second surfaces, the inclined surface being so inclined as to become more distant from the inner surface of the glass cover as proceeding toward the second surface.

2. The image reading apparatus according to claim 1, wherein the inner surface of the glass cover consists of a bonding region to be bonded to the opening and a non-bonding region, the non-bonding region being designed to more readily repel resin than the bonding region does.

3. The image reading apparatus according to claim 1, wherein a supporting surface facing the inner surface of the glass cover and bonded to at least part of the inner surface of the glass cover is provided substantially along an entire length of the opening in the primary scanning direction, the supporting surface being formed with a plurality of ejector pin traces recessed in a direction to be away from the glass cover, the ejector pin traces being smaller than the supporting surface in dimension in the secondary scanning direction.

4. The image reading apparatus according to claim 3, wherein the ejector pin trace includes a bottom surface facing the inner surface of the glass cover and an inclined surface which is so inclined as to become closer to the inner surface of the glass cover as proceeding away from center of the bottom surface.

5. The image reading apparatus according to claim 1, wherein the opening includes a side wall surface facing a side surface of the glass cover, the side wall surface being formed with a resin injection hole communicating with outside.

6. An image reading apparatus comprising:
a light source;
a plurality of light receiving elements arranged in a primary scanning direction;
a light guide for directing light emitted from the light source toward an object to be read as linear light extending in the primary scanning direction;
a lens member for guiding reflected light of the linear light toward the light receiving elements;
a case accommodating the light source, the light receiving elements, the light guide and the lens member, the case being in the form of an elongated rectangle and including an opening extending in the primary scanning direction; and
a glass cover fitted in the opening;
wherein the opening is provided with a supporting surface facing an inner surface of the glass cover and bonded to at least part of the inner surface of the glass cover;
wherein the supporting surface is formed with a plurality of ejector pin traces recessed in a direction to be away from the glass cover;
wherein the supporting surface is provided substantially along an entire length of the opening in the primary scanning direction; and
wherein the ejector pin traces are smaller than the supporting surface in dimension in the secondary scanning direction.

7. The image reading apparatus according to claim 6, wherein the ejector pin trace includes a bottom surface facing the inner surface of the glass cover and an inclined surface which is so inclined as to become closer to the inner surface of the glass cover as proceeding away from center of the bottom surface.

8. The image reading apparatus according to claim 6, wherein the opening includes a side wall surface facing a side surface of the glass cover, the side wall surface being formed with a resin injection hole communicating with outside.
